(19) United States
(12) Patent Application Publication
(10) Pub. No.: US 2015/0371154 A1
(43) Pub. Date: Dec. 24, 2015

(54) METHOD AND SYSTEM FOR SHARING SURPLUS PERSONAL RESOURCE FOR TRAVEL CONVENIENCE

(71) Applicant: NAVER CORPORATION, Seongnam-si (KR)

(72) Inventors: Yoon Shick Lee, Seongnam-si (KR); Yeon Ju Park, Seongnam-si (KR); Min Oh Kim, Seongnam-si (KR)

(21) Appl. No.: 14/743,559

(22) Filed: Jun. 18, 2015

(30) Foreign Application Priority Data
Jun. 19, 2014 (KR) 10-2014-0075156

(51) Int. Cl. G06Q 10/02

(52) U.S. Cl. CPC G06Q 10/02

(57) ABSTRACT

A method and system for sharing a surplus personal resource for travel convenience includes connecting a provider of a resource for travel convenience who provides his or her surplus resources as travel resources, and a user of a resource for travel convenience who needs the travel resources; discussing conditions for sharing the travel resource between the provider of the resource for travel convenience and the user of the resource for travel convenience to reach an agreement for the sharing conditions; and creating agreement information according to the sharing conditions and establishing sharing of the surplus personal resource for travel convenience between the provider of the resource for travel convenience and the user of the resource for travel convenience, thereby enabling an individual having surplus resources such as surplus time, space, transportation means, or the like to share it with a traveler who needs the surplus resources.

### BACKGROUND OF THE INVENTION

1. Field of the Invention

The present invention relates to a method and system for sharing a surplus personal resource for travel convenience. More particularly, the present invention relates to a method of connecting an individual who possesses a surplus personal resource, such as personal time, living space, transportation means, or the like, and a traveler who needs the surplus resource, thereby enabling the individual and the traveler to share the surplus resource, and additionally relates to a system for implementing the method.

2. Description of the Related Art

According to the development of the living environment and transportation means, people's needs for long-distance trips and trips to unfamiliar regions have been increasing. However, when a traveler travels in an unfamiliar region or a foreign country in which acquaintances or personal connections are not present, it is difficult for the traveler to obtain sufficient information about travel resources, such as a guide, living space, transportation means (i.e., means or mode of transportation), and the like. Due to this, the traveler completely entrusts the process for reserving appropriate travel resources to a travel agency or a travel broker.

Like the method of providing travel resources illustrated in FIG. 1, a traveler 10 receives various kinds of travel resource information 50, such as information about living spaces in the region targeted for travel, vehicles, guides, and the like, solely from a tourism company 30, such as a travel agency or the like, and allows the tourism company to reserve the travel resources that he or she needs within the scope of the travel resource information provided by the tourism company.

Such reservation of travel resources though a professional tourism company is performed in the state in which the travel resources are limited to hotels, rented vehicles, professional guides, and the like that are affiliated with the tourism company, thereby resulting in increased travel costs.

In order to further reduce increased travel costs, a travel service for locating optimum travel resources by comparing various prices of tourism companies or hotels, and for making a reservation for a traveler has been recently created. However, since this travel service is also performed in the state in which the travel resources are limited to travel resources that are provided by professional travel resource-providing companies such as hotels, travel agencies, and the like, the traveler still has the burden of high travel costs. In particular, because the travel service is performed in the state in which the travel resources are limited to similar or standardized travel resources, it is problematic in that the travel service is not appropriate for travelers who desire to have various and characterful trips or field experiences.

Furthermore, in order to promote various and characterful trips or field experiences at low cost, even though travel resource information may be obtained through individual blogs or web sites providing lodging information about B&Bs or guest houses and the like operated by individuals, or guide information about freelance guides and the like, and such travel resources may be reserved, it is difficult for a provider of a resource for travel convenience to maintain and manage a blog or a web site for providing his or her own travel resource information. Also, users of resources for travel convenience are required to spend a lot of time finding optimum travel resources by searching individual blogs, web sites and the like.

Even though a service for providing travel resource information provided by individuals and a relaying service for making reservations have been used, in the case of the relaying service for personal travel resources, it has been possible to make a reservation only under the conditions unilaterally presented by the provider of a resource for travel convenience. Thus, since only unilateral requirements are presented, without any agreement between individuals, these services have a limit in their ability to efficiently induce agreements to provide and use travel resources.

Moreover, despite the fact that there are many people who desire to meet foreigners in various foreign countries and to use foreign languages by sharing surplus resources such as their surplus time, space, transportation means and the like with travelers as travel resources, in reality it is not easy for an individual having surplus resources to find a traveler with whom to share the surplus resources.

### SUMMARY OF THE INVENTION

Accordingly, the present invention has been made keeping in mind the above problems occurring in the related art, and an object of the present invention is to provide a method and system for sharing surplus personal resources for travel convenience by connecting a person who desires to provide his or her surplus resources as travel resources and a person who needs the travel resources, so that a traveler can have a characterful trip and field experiences at a low cost.

In particular, another object of the present invention is to provide a method and system for sharing surplus personal resources for travel convenience, the method and system being capable of solving the problem of increased travel costs that occurs because travel resources are limited to hotels, rental cars, professional guides and the like that are affiliated with a particular travel agency or a travel broker when a reservation for the travel resource is performed by the travel agency or the travel broker, and capable of overcoming the drawback of similar or standardized travel resources that are not appropriate for travelers who desire to have various and characterful trips or field experiences.

Furthermore, a further object of the present invention is to provide a method and system for sharing surplus personal resources for travel convenience, which enables travelers to share surplus resources such as surplus personal time, space, transportation means, and the like so that individuals having travel resources who desire to meet people in various foreign countries or to use a foreign language can be connected with travelers who need the travel resources, thereby enabling the sharing of surplus resources among individuals.

Moreover, yet another object of the present invention is to provide a method and system for sharing surplus personal resources for travel convenience, which enable a provider, who provides surplus resources, and a user, who uses the surplus resources, to efficiently share the surplus resources by discussing conditions for sharing the travel resources between the provider and the user to reach an agreement for the sharing conditions.

In order to achieve the above objects, according to one aspect of the present invention, there is provided a method for sharing surplus personal resources for travel convenience, comprising: connecting a provider of a resource for travel convenience, who provides his or her surplus resource as a travel resource, and a user of a resource for travel convenience, who needs the travel resource; discussing conditions for sharing the travel resource between the provider of the resource for travel convenience and the user of the resource for travel convenience to reach an agreement for the sharing conditions; and creating sharing agreement information according to the sharing conditions and establishing sharing of the surplus personal resource for travel convenience between the provider of the resource for travel convenience and the user of the resource for travel convenience.

Preferably, connecting the provider of the resource for travel convenience and the user of the resource for travel convenience may include: storing surplus resource information about at least one of an unreserved time schedule for a guide, a surplus living space for accommodation, and a surplus transportation means possessed by the provider of the resource for travel convenience; receiving sharing condition information about at least one of a time schedule for a guide, accommodations and a transportation means requested and inputted by the user of the resource for travel convenience, and searching surplus resource information corresponding to the sharing condition information; providing the searched surplus resource information to the user of the resource for travel convenience; and confirming conditions for sharing the selected surplus resource according to the selection of the surplus resource information by the user of the resource for travel convenience.

Also, connecting the provider of the resource for travel convenience and the user of the resource for travel convenience may include: storing travel resource request information about at least one travel resource of a time schedule for a guide, accommodations, and transportation means requested by the user of the resource for travel convenience; receiving sharing condition information for at least one surplus resource among an unreserved time schedule for a guide, surplus living space for accommodations, and surplus transportation means inputted by the provider of the resource for travel convenience and searching the travel resource request information corresponding to the sharing condition information; providing the searched travel resource request information to the provider of the resource for travel convenience; and confirming the conditions for sharing the selected travel resource request information according to the selection of the travel resource request information by the provider of the resource for travel convenience.

Preferably, confirming the sharing conditions may be performed by further providing a credit rating or an evaluation review for the provider of the resource for travel convenience or the user of the resource for travel convenience.

Furthermore, discussing the sharing conditions may include: holding a consultation about the conditions for sharing the travel resource between the provider of the resource for travel convenience and the user of the resource for travel convenience; and reaching an agreement for sharing of the travel resource between the provider of the resource for travel convenience and the user of the resource for travel convenience according to the sharing conditions.

Preferably, holding a consultation about the conditions for sharing the travel resource may be performed by providing at least one agreement mechanism selected from among a chatting box, a message box between the provider of the resource for travel convenience and the user of the resource for travel convenience, and an edit box for inputting the sharing conditions, and by discussing the sharing conditions via the agreement mechanism.

Furthermore, establishing the sharing of the travel resource may include: creating and storing sharing agreement information according to the conditions for sharing the travel resource agreed upon between the provider of the resource for travel convenience and the user of the resource for travel convenience; and providing a reward to the provider of the resource for travel convenience according to the agreed-upon sharing information.

Here, the reward may be provided in such a manner that the provider of the resource for travel convenience provides a surplus resource for free, cash or points may be provided to the provider of the resource for travel convenience, or surplus resources may be exchanged between the user of the resource for travel convenience and the provider of the resource for travel convenience.

Also, according to another aspect of the present invention, there is provided a system for sharing a surplus personal resource for travel convenience. The system includes a travel resource information storage unit adapted to store surplus resource information, inputted by a provider of a resource for travel convenience, or travel resource request information, inputted by a user of a resource for travel convenience; a user connection unit, adapted to connect the provider of the resource for travel convenience and the user of the resource for travel convenience, and to induce an agreement for conditions for sharing a travel resource between the provider of the resource for travel convenience and the user of the resource for travel convenience; and a sharing agreement information generation unit, adapted to establish sharing of the travel resource based on the conditions for sharing the travel resource agreed upon between the provider of the resource for travel convenience and the user of the resource for travel convenience and to create and store sharing agreement information resulting therefrom.

Furthermore, the system may further include a user information storage unit adapted to store user information about the provider of the resource for travel convenience and user information about the user of the resource for travel convenience.

Preferably, the user connection unit may include: a travel resource matching part, adapted to enable the travel resource information storage unit to search surplus resource information or travel resource request information based on sharing condition information inputted by the user of a resource for travel convenience or the provider of the resource for travel convenience and to provide the searched surplus resource information or travel resource request information to the user of the resource for travel convenience or the provider of the resource for travel convenience; and an agreement mechanism providing part adapted to provide an agreement mechanism for discussing sharing conditions regarding the surplus resource information selected by the user of the resource for travel convenience, or sharing conditions regarding travel resource request information selected by the provider of the resource for travel convenience.

Preferably, the agreement mechanism providing part may provide, as an agreement mechanism, a chatting box, a message box between the user of the resource for travel convenience and the provider of the resource for travel convenience, or a box for editing sharing conditions.

Furthermore, the sharing agreement information generation unit may create sharing agreement information including information about any reward selected from among rewards of no charge, cash, points, and an exchange resulting from sharing of the travel resource, and the user information storage unit may store the sharing agreement information by matching it with the user.

Also, the user information storage unit may store a credit rating or an evaluation review for the provider of the resource for travel convenience or the user of the resource for travel convenience, and the user connection unit may provide the credit rating or an evaluation review for the provider of the resource for travel convenience or user of the resource for travel convenience.

According to the present invention, an individual having a surplus resource, such as surplus personal time, space, transportation means and the like, can be connected with a traveler who needs the surplus resource, and the surplus resource can be shared.

In particular, since the surplus resource can be shared between individuals as a travel resource, a provider of a resource for travel convenience can more efficiently utilize his or her surplus resource, and a user of a resource for travel convenience can take a characterful trip capable of providing a field experience at a low cost.

Furthermore, since a surplus resource is shared between individuals as a travel resource, sharing conditions that are satisfactory for both the resource provider and the resource user can be reached by providing an agreement process therebetween.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 illustrates a conceptual view showing a method of providing a travel resource according to conventional art;

FIG. 2 illustrates a conceptual view showing sharing of travel resources performed between individuals for travel convenience according to the present invention;

FIG. 3 illustrates a block diagram showing an embodiment of a service server in a system for sharing a surplus personal resource for travel convenience according to the present invention;

FIG. 4 illustrates a block diagram showing an embodiment of a user's connection unit with regard to the system for sharing a surplus personal resource for travel convenience;

FIG. 5 illustrates a flow chart showing an embodiment of a method for sharing a surplus personal resource for travel convenience according to the present invention;

FIG. 6 illustrates a flow chart showing one embodiment for connecting a provider of a resource for travel convenience and a user of a resource for travel convenience with regard to the method for sharing a surplus personal resource for travel convenience according to the present invention;

FIG. 7 illustrates an implementation example of surplus resource information with regard to the embodiment of FIG. 6;

FIG. 8 illustrates an implementation example of detailed surplus resource information for the provider of the resource for travel convenience with regard to the embodiment of FIG. 6;

FIG. 9 illustrates a flow chart showing another embodiment for connecting users with regard to the method for sharing a surplus personal resource for travel convenience according to the present invention;

FIG. 10 illustrates a flow chart showing an embodiment of an agreement process for sharing conditions with regard to the method for sharing a surplus personal resource for travel convenience according to the present invention;

FIG. 11 illustrates one implementation example of the agreement process of sharing conditions with regard to the embodiment of FIG. 10;

FIG. 12 illustrates another implementation example regarding the agreement process of sharing conditions with regard to the embodiment of FIG. 10; and

FIGS. 13A and 13B illustrate an implementation example of sharing agreement information with regard to the method for sharing a surplus personal resource for travel convenience according to the present invention.

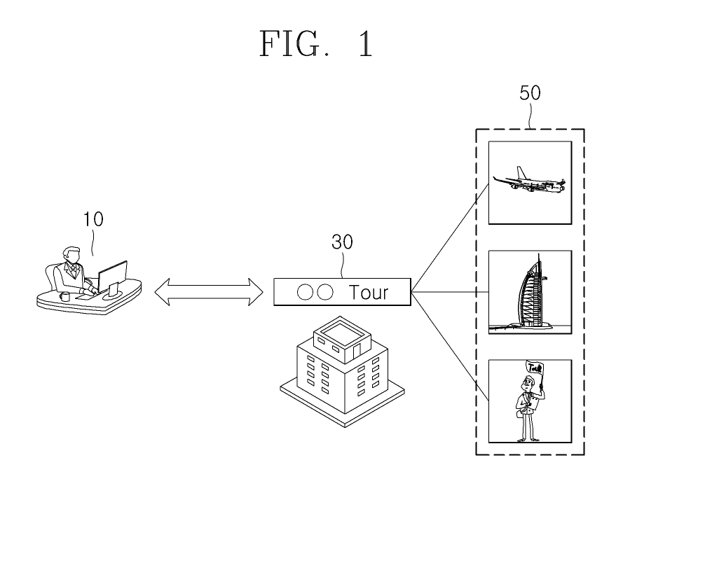

### DETAILED DESCRIPTION OF THE INVENTION

Hereinbelow, preferred embodiments of the present invention will be described in detail with reference to the accompanying drawings in order to describe operational advantages of the present invention and objects achieved by the present invention.

First, the terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

In the following description, it is to be noted that, when the functions of conventional elements and the detailed description of elements related with the present invention may make the gist of the present invention unclear, a detailed description of those elements will be omitted.

The present invention suggests a method for sharing surplus resources between individuals as travel resources.

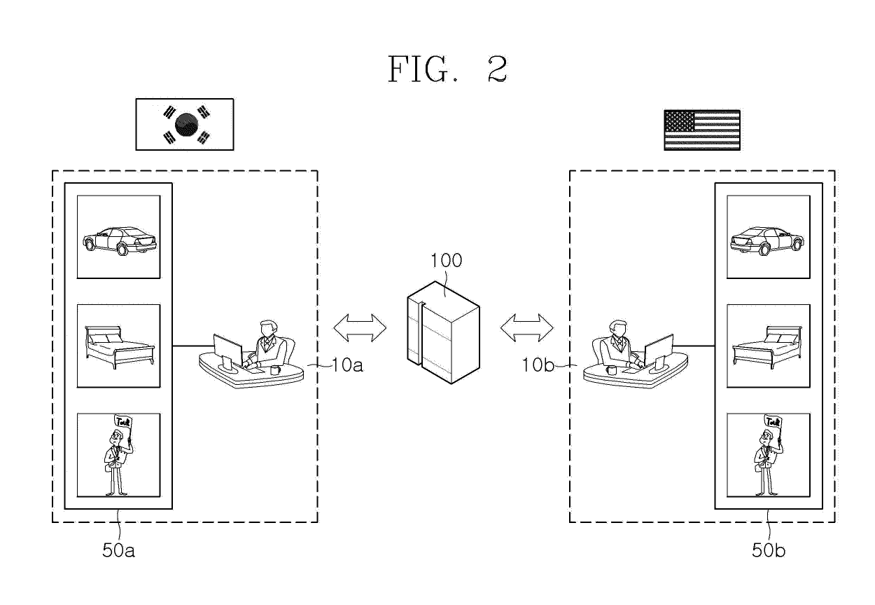

FIG. 2 illustrates a conceptual view showing the sharing of travel resources performed between individuals for travel convenience according to the present invention. A method for sharing individual surplus resources will be reviewed with reference to FIG. 2.

A first user 10a is a person who desires to provide surplus resources 50a regarding his or her own vehicle, living space, time availability as a guide, or the like as travel resources for providing travel convenience to travelers, namely, a provider of a resource for travel convenience. A second user 10b is a person who needs a travel resource, namely, a user of a resource for travel convenience. FIG. 2 illustrates that the second user 10b may also provide his or her surplus resources 50b regarding his or her own vehicle, living space, time availability as a guide, or the like. However, this is only one example, and the second user 10b may be a person who simply needs other people's travel resources as travel resources without providing his or her surplus resources.

Furthermore, a service server 100 for enabling the first user 10a and the second user 10b to share surplus resources as travel resources performs a function of performing sharing relaying regarding surplus resources between the first user 10a and the second user 10b.

The first user 10a and the second user 10b may access the service server 100 via various communication apparatuses, such as a general PC, a smart phone, a PDA, and the like. To do so, the service server 100 may be configured to provide a web service accessed via a network based on various communication methods, such as an internet network, a mobile communication network, or the like, or to provide a service accessed via an application installed in a smart phone.

The service server 100 may mutually connect the first user 10a, who is a provider of a resource for travel convenience, and the second user 10b, who is a user of a resource for travel convenience, so that the first user 10a can share his or her surplus resource as a travel resource with the second user 10b. The first user 10a may provide his or her surplus resource for free, or may receive a reward such as a monetary reward, a point reward, or the like in return. As an example, a service server 100 may receive cash or points from a second user 10b and give a reward to the first user 10a. Furthermore, when the second user 10b, who is the user of a resource for travel convenience, desires to share his or her surplus resource as a travel resource with the first user 10a, the first user 10a and the second user 10b may exchange their surplus resources according to an agreement reached therebetween.

As such, the present invention suggests a method for sharing surplus personal resources as travel resources by mutually connecting a provider of a resource for travel convenience and a user of a resource for travel convenience.

Hereinafter, a system for sharing a surplus personal resource for travel convenience according to the present invention will be first reviewed with reference to exemplary embodiments, and a method for sharing a surplus personal resource for travel convenience according to the present invention will be reviewed in detail with reference to these embodiments.

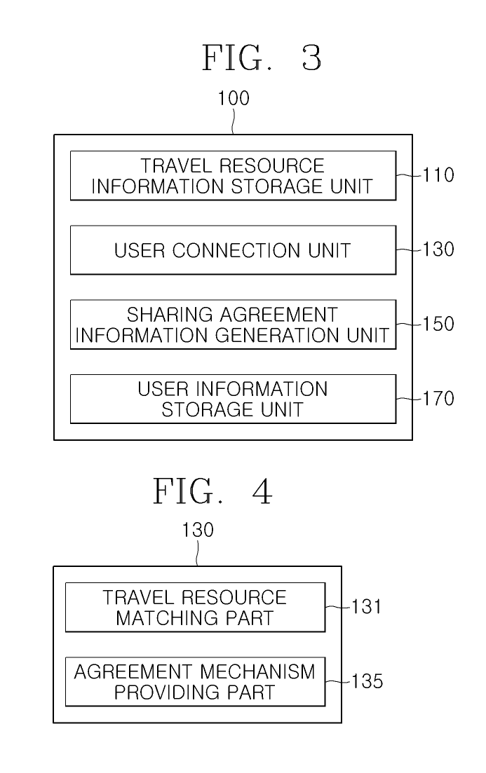

FIG. 3 illustrates a block diagram showing an embodiment of a service server 100 formed in a system for sharing a surplus personal resource for travel convenience according to the present invention.

The service server 100 according to the present embodiment of the invention includes a travel resource information storage unit 110; a user connection unit 130; and a sharing agreement information generation unit 150. In addition to these, the service server 100 further includes a user information storage unit 170. The service server 100 may be either a hardware server or a software server. The service server 100 may be entirely hardware, entirely software or a combination of hardware and software. The service server may include a processor, memory, applications, a database and other functional components.

The travel resource information storage unit 110 may store surplus resource information provided by a provider of a resource for travel convenience as a travel resource, or may store travel resource information requested and inputted by a user of a resource for travel convenience. Furthermore, the travel resource information storage unit 110 may store both surplus resource information and requested resource information with regard to one user when the one user is both a user of a resource for travel convenience requiring a travel resource and a provider of a resource for travel convenience providing his or her surplus resources as travel resources.

Here, the surplus resource information stored in the travel resource information storage unit 110 may be stored by matching resources of the provider of a resource for travel convenience regarding time availability as a guide, surplus living space for accommodation, unused vehicles, and the like with sharing conditions, such as a surplus day and time, a surplus region, the kind of reward, and the like.

The user connection unit 130 connects a provider of a resource for travel convenience with a user of the resource for travel convenience, and enables the provider of the resource for travel convenience and the user of the resource for travel convenience to reach an agreement for conditions for sharing the travel resource.

To do so, the user connection unit 130 receives sharing condition information, inputted by the provider of the resource for travel convenience or the user of the resource for travel convenience, and extracts travel resource request information or surplus resource information corresponding to the information from the travel resource information storage unit 110. Furthermore, the user connection unit 130 enables the provider of the resource for travel convenience and the user of the resource for travel convenience to discuss sharing conditions by providing an agreement mechanism.

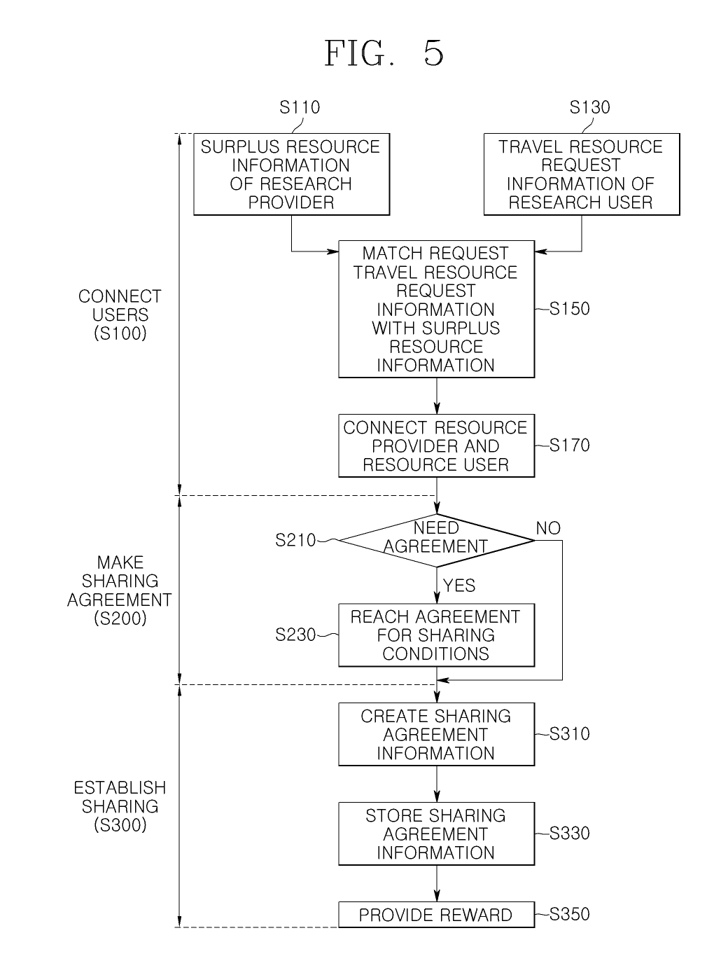

Reviewing the user connection unit 130 with reference to a diagram view of FIG. 4, showing an embodiment of the user connection unit with regard to the system for sharing a surplus personal resource for travel convenience according to the present invention, the user connection unit 130 may include a travel resource matching part 131 and an agreement mechanism providing part 135.

The travel resource matching part 131 searches the surplus resource information or the travel resource request information via the travel resource information storage unit 110 based on the sharing conditions inputted by the user of the resource for travel convenience or the provider of the resource for travel convenience, and provides the searched information to the user of the resource for travel convenience or the provider of the resource for travel convenience.

Furthermore, the agreement mechanism providing part 135 provides an agreement mechanism for discussing the sharing conditions regarding the surplus resource information selected by the user of the resource for travel convenience and the sharing conditions regarding the travel resource request information selected by the provider of the resource for travel convenience, and may provide, as the agreement mechanism, a chatting box, a message box, an edit box for inputting sharing conditions, or the like between the user of the resource for travel convenience and the provider of the resource for travel convenience.

Returning to FIG. 3 again, when the user of the resource for travel convenience and the provider of the resource for travel convenience reach an agreement for the sharing conditions regarding the travel resource, the sharing agreement information generation unit 150 creates and stores sharing agreement information by establishing sharing of the travel resource based on the sharing conditions regarding the travel resource agreed upon between the provider of the resource for travel convenience and the user of the resource for travel convenience.

Here, the sharing agreement information may include information about the sharing conditions agreed upon between the provider of the resource for travel convenience and the user of the resource for travel convenience, along with the travel resource information corresponding thereto, and may be substantially a kind of voucher.

Furthermore, the sharing conditions may include reward information resulting from sharing the travel resource. The reward information in the present invention results from the case in which a travel resource is provided for free, and a case in which a cash or point reward is provided in consideration of having provided a travel resource. Also, it may result from the case in which users mutually exchange their travel resources.

Moreover, the service server 100 further includes the user information storage unit 170. The user information storage unit 170 stores user information about the provider of the resource for travel convenience and the user of the resource for travel convenience, and may preferably store information about credit ratings, evaluation reviews, or the like for the provider of the resource for travel convenience and the user of the resource for travel convenience by matching the information with the corresponding provider or user. Here, the credit ratings or evaluation reviews for the provider and the user may be ratings calculated based on numerical values assigned by other users having the experience of sharing travel resources with the corresponding user, or review information written by the other users.

Furthermore, information about the credit ratings or the evaluation reviews of the corresponding user stored in the user information storage unit 170 may be additionally provided when the provider of the resource for travel convenience and the user of the resource for travel convenience are connected via the user connection unit 130.

Also, although not shown in FIG. 3, the service server 100 may basically have a communication interface for enabling the provider of the resource for travel convenience and the user of the resource for travel convenience to be connected to each other via various communication apparatuses, wherein the communication interface may be implemented in various communication methods via various communication networks, such as an internet network, a mobile communication network, and the like. However, a limitative description thereof is omitted.

As such, based on the service server 100 according to the present invention, the system for sharing a surplus personal resource as a travel resource between users may be established. In the present invention, a method for sharing a surplus personal resource for travel convenience may be implemented using the system for sharing the surplus personal resource for travel convenience according to the present invention, reviewed above.

Hereinafter, a method for sharing a surplus personal resource for travel convenience according to the present invention will be reviewed with reference to exemplary embodiments. Since the method for sharing a surplus personal resource for travel convenience according to the present invention is implemented based on the system for sharing the surplus personal resource for travel convenience according to the present invention reviewed above, the method will be reviewed with reference to the embodiments of the system, as well as the embodiments of the method.

FIG. 5 illustrates a flow chart showing an embodiment of the method for sharing a surplus personal resource for travel convenience according to the present invention.

The method for sharing a surplus personal resource for travel convenience according to the present invention includes: connecting a provider of a resource for travel convenience, who provides his or her surplus resource as a travel resource, with a user of a resource for travel convenience who needs the travel resource (S100); discussing conditions for sharing the travel resource between the provider of the resource for travel convenience and the user of the resource for travel convenience (S200) to reach an agreement for sharing conditions; creating agreement information according to the sharing conditions and establishing sharing of the surplus personal resource for travel convenience between the provider of the resource for travel convenience and the user of the resource for travel convenience (S300).

Reviewing each step more specifically, connecting the provider of the resource for travel convenience and the user of the resource for travel convenience (S100) includes: matching surplus resource information, inputted by the provider of the resource for travel convenience, with travel resource information requested by the user of the resource for travel convenience in a state in which the surplus resource information (S110) is retained or stored, thereby connecting the provider of the resource for travel convenience with the user of the resource for travel convenience (S170). Connecting the provider of the resource for travel convenience and the user of the resource for travel convenience (S100) may also include matching the travel resource request information with the surplus resource information inputted by the provider of the resource for travel convenience (S150) in a state in which the travel resource request information inputted by the user of the resource for travel convenience (S130) is retained, thereby connecting the provider of the resource for travel convenience with the user of the resource for travel convenience (S170).

When the provider of a resource for travel convenience and the user of a resource for travel convenience are connected to each other, discussing the sharing conditions (S200)includes: confirming whether an agreement for sharing conditions for the travel resource is required between the provider of the resource for travel convenience and the user of the resource for travel convenience (S210); and establishing sharing of the travel resource when the sharing conditions are agreed upon (S300) or providing an agreement mechanism for discussing the sharing conditions when the sharing conditions are not agreed upon (S230), thereby helping the provider of the resource for travel convenience and the user of the resource for travel convenience to reach an agreement for the sharing conditions (S230).

When the provider of a resource for travel convenience and the user of a resource for travel convenience reach an agreement for the sharing conditions, establishing the sharing of the surplus personal resource (S300)includes: creating sharing agreement information according to the sharing conditions agreed upon for the travel resource (S310); and storing the created information (S330). Also, establishing the sharing of the surplus personal resource may further include providing a reward according to the sharing conditions (S350).

The respective steps, viewed broadly above, will be reviewed in greater detail based on implementation examples.

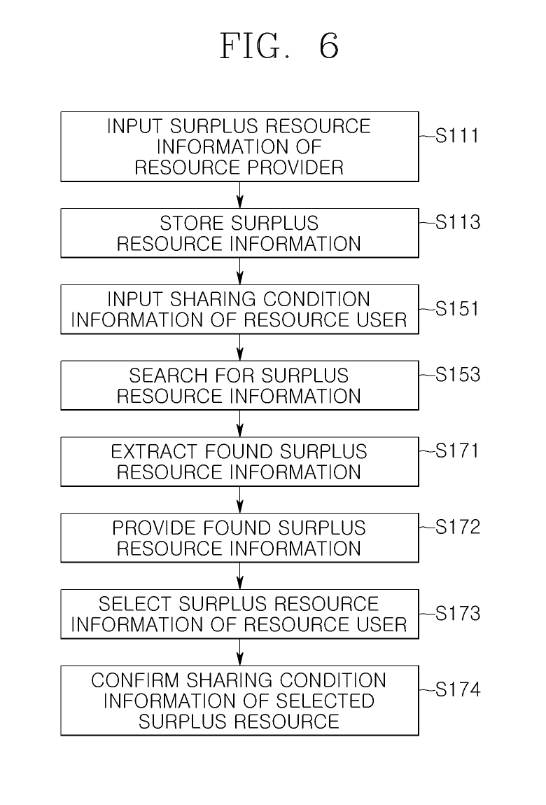

FIG. 6 illustrates one embodiment showing a process for connecting users with regard to the method for sharing a surplus personal resource for travel convenience according to the present invention.

The embodiment of FIG. 6 shows a process for connecting the provider of a resource for travel convenience and the user of the resource for travel convenience in a state in which the surplus resource information of the provider of the resource for travel convenience is retained or stored. First, the travel resource information storage unit 110 receives at least one kind of surplus resource information about an unreserved time schedule for a guide, surplus living space for accommodation, transportation means such as a vehicle, or the like, inputted by the provider of the resource for travel convenience (S111), and stores the surplus resource information (113). At this time, the surplus resource information includes sharing condition information such as the available date and time information, reward information, and the like. The surplus resource information may be stored in a travel resource information storage unit 110 in a state of being classified based on sharing conditions.

As such, in the state in which various kinds of surplus resource information are contained in the travel resource information storage unit 110, the travel resource matching part 131 of the user connection unit 130 receives at least one kind of sharing condition information regarding a guide, a living space, or transportation means requested and inputted by the user of a resource for travel convenience (S151), and the travel resource information storage unit 110 searches for surplus resource information corresponding to the requested sharing condition information (S153). Furthermore, the travel resource matching part 131 of the user connection unit 130 extracts the found surplus resource information from the travel resource information storage unit 110 (S171) and provides a list of the found surplus resource information to the user of a resource for travel convenience (S172).

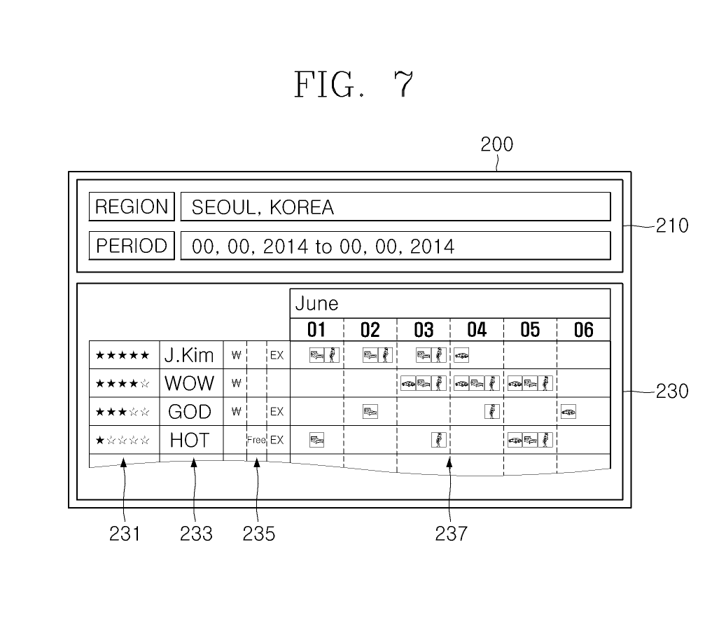

Reviewing an implementation example, in which surplus resource information is provided, FIG. 7 shows an example 200 which is provided by the service server 100 as a web service. In the implementation example, when a user of a resource for travel convenience connects to the web service of the service server 100 via a communication means such as a PC or the like, and inputs sharing condition information into an edit box 210 of the sharing condition information for travel resources via the travel resource matching part 131 of the user connection unit 130, the travel resource matching part 131 enables the travel resource information storage unit 110 to search for surplus resource information based on the inputted sharing condition information, and extracts at least one piece of surplus resource information matching the sharing condition information, thereby providing a list 230 of the extracted surplus resource information to the user of a resource for travel convenience.

A credit rating 231 and an ID 233 of a provider of a resource for travel convenience are displayed as the provided surplus resource information. Furthermore, various kinds of surplus resource information 230, including the kind of reward 235, the kind of surplus resources, the service date, and the like as sharing conditions are displayed via the web service.

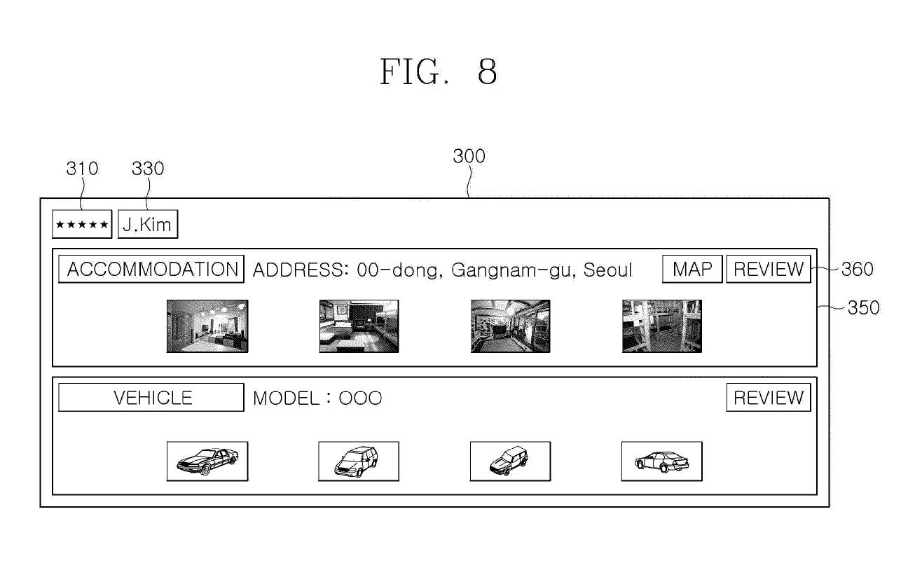

Going back to FIG. 6, when the user of a resource for travel convenience selects any one piece of the surplus resource information based on the various pieces of the surplus resource information reviewed above (S173), he or she may confirm the sharing condition information for the selected surplus resource information (S174). FIG. 8 shows an implementation example of the detailed surplus resource information provided by the provider of a resource for travel convenience. A credit rating 310 and the ID 330 of the corresponding provider of the resource for travel convenience are displayed as the detailed information 300 about specific surplus resources. Furthermore, detailed sharing information about a living space 350, a vehicle and the like provided by the provider of the resource for travel convenience is displayed. Furthermore, when clicking a review box for evaluation reviews of the surplus resources, the user of the resource for travel convenience may be provided with evaluation reviews 360 written by other resource users for travel convenience who have experience as users of the surplus resources.

As such, in the present invention, various kinds of surplus resource information, as well as information about the provider of a resource for travel convenience, may be provided to the user of a resource for travel convenience so that the user of a resource for travel convenience can select more accurate and reliable surplus resource information.

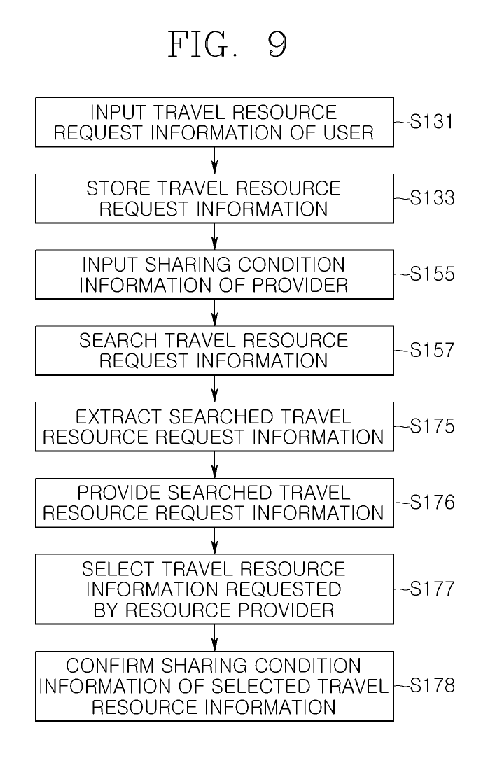

FIG. 9 illustrates another embodiment showing a process for connecting users with regard to the method for sharing a surplus personal resource for travel convenience according to the present invention.

The embodiment of FIG. 9 shows a process for connecting a provider of a resource for travel convenience and a user of a resource for travel convenience in a state in which travel resource information, requested by the user of the resource for travel convenience, is retained. In the embodiment, first, the travel resource information storage unit 110 receives travel resource information about at least one travel resource among guide time, a living space, a transportation means, and the like, requested and inputted by the user of a resource for travel convenience (S131), and stores the travel resource request information (S133). Here, the travel resource request information includes sharing condition information, such as information about the kind of travel resources, requested day and time information, reward information, and the like. The travel resource information storage unit 110 may store the travel resource request information in the state of being classified based on sharing conditions.

As such, in the state in which various pieces of travel resource request information are possessed in the travel resource information storage unit 110, the travel resource matching part 131 of the user connection unit 130 receives sharing condition information about at least one surplus resource selected from an unreserved time schedule for a guide, surplus living space for accommodation, and a surplus transportation means, inputted by the provider of a resource for travel convenience (S155), and the travel resource information storage unit 110 searches travel resource request information corresponding to the sharing condition information (S157). The travel resource matching part 131 of the user connection unit 130 extracts the searched travel resource information from the travel resource information storage unit 110 (S175), thereby providing a list of the searched travel resource information to the provider of a resource for travel convenience (S176).

Based on various kinds of travel resource request information provided by the resource users, when the provider of a resource for travel convenience selects any one kind of travel resource request information (S177), sharing condition information for the selected travel resource request information may be confirmed (S178).

Since an implementation example for the embodiment of FIG. 9 may be deduced based on the implementation examples of FIGS. 7 and 8 in light of FIG. 6, which was previously reviewed, a detailed explanation of the implementation example is omitted.

As such, in the present invention, various kinds of surplus resource information, as well as information about the provider of a resource for travel convenience, may be provided to the user of a resource for travel convenience so that the user of a resource for travel convenience can select more accurate and reliable surplus resource information.

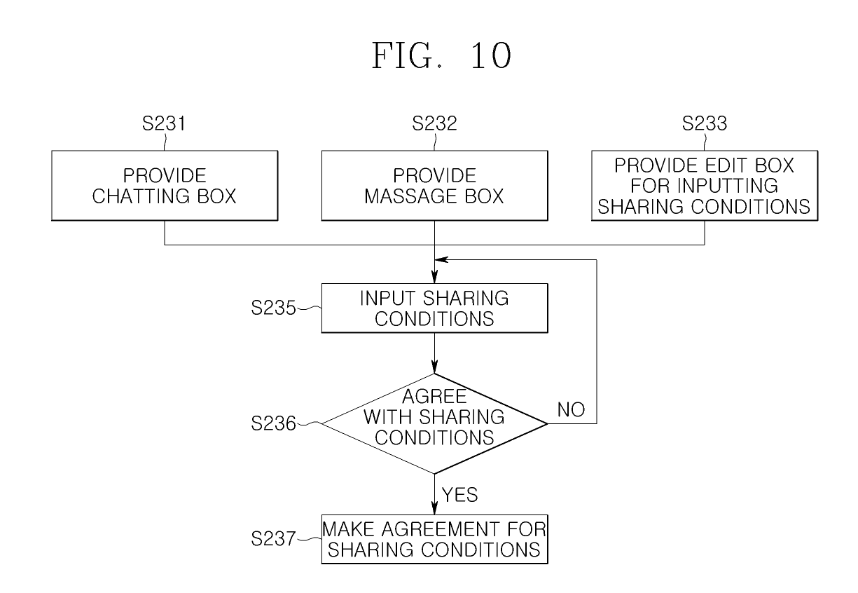

Through the embodiment as shown in FIG. 6 or FIG. 9, connecting the provider of the resource for travel convenience with the user of the resource for travel convenience (S100) is performed so that the provider of the resource for travel convenience and the user of the resource for travel convenience can be connected to each other, and thereafter, discussing the sharing conditions (S200) is performed, so that the sharing conditions can be discussed between the provider of the resource for travel convenience and the user of the resource for travel convenience. FIG. 10 illustrates an embodiment showing the process of agreeing on sharing conditions with regard to the method for sharing a surplus personal resource for travel convenience according to the present invention.

Based on the embodiment of FIG. 6, when a user of a resource for travel convenience selects surplus resource information provided by a provider of a resource for travel convenience and desires to change the sharing conditions with regard to the sharing of the selected surplus resource, or based on the embodiment of FIG. 9, when a provider of a resource for travel convenience selects travel resource information requested by the user of a resource for travel convenience and desires to change the sharing conditions with regard to the sharing of the travel resource request information, the agreement mechanism providing part 135 of the user connection unit 130 forms an agreement communication channel between the provider of the resource for travel convenience and the user of the resource for travel convenience, and may provide a chatting box (S231), a message box (S232), or a box for editing sharing conditions (S233) according to the selection by the user of the resource for travel convenience.

Through such an agreement communication channel, the provider of a resource for travel convenience and the user of the resource for travel convenience input their desired sharing conditions (S235) while proceeding with an agreement for sharing conditions. When each of the provider and the user agrees with the sharing conditions presented by the other (S236), an agreement for the sharing conditions is established (S237), and when each of the provider and the user does not agree with the sharing conditions presented by the other (S236), the process for inputting sharing conditions (S235) may be repeatedly performed by each of the provider and the user.

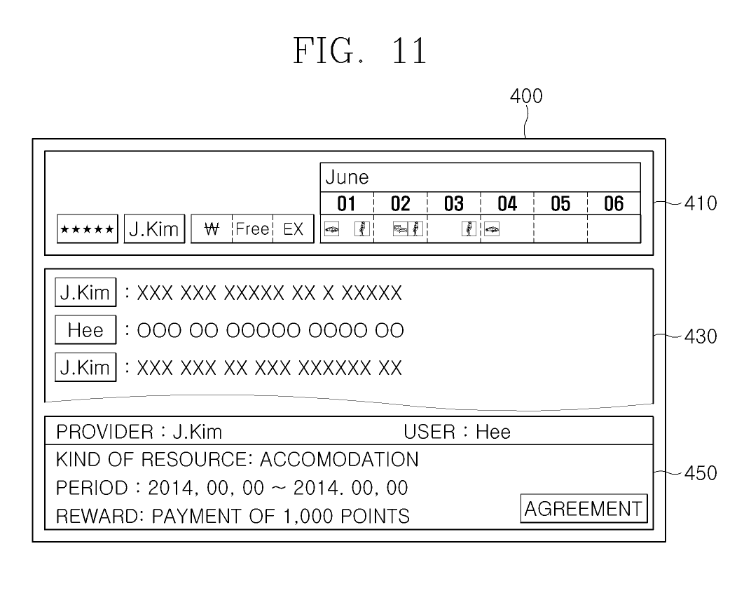

FIG. 11 illustrates one example of the implementation of the agreement process for sharing conditions with regard to the embodiment of FIG. 10. According to a request for agreement on sharing conditions of the provider of a resource for travel convenience or the user of a resource for travel convenience, the agreement mechanism providing part 135 of the user connection unit 130 provides an agreement mechanism 400 via a web service. In FIG. 11, a chatting box 430 is formed as an agreement communication channel between the provider of a resource for travel convenience and the user of a resource for travel convenience.

In FIG. 11, an agreement process with regard to sharing condition information 410 presented by the provider of a resource for travel convenience is performed. With regard to the presented sharing information 410, the provider of a resource for travel convenience and the user of the resource for travel convenience mutually proceed with the agreement process via the chatting box 430. When an agreement for sharing conditions is reached according to the agreement process, the sharing conditions 450 that changed during the agreement process are inputted, and mutual agreement on the changed sharing conditions is required. In this regard, when the provider of the resource for travel convenience and the user of the resource for travel convenience agree on the sharing conditions, the agreement for surplus resources is established according to the changed sharing conditions.

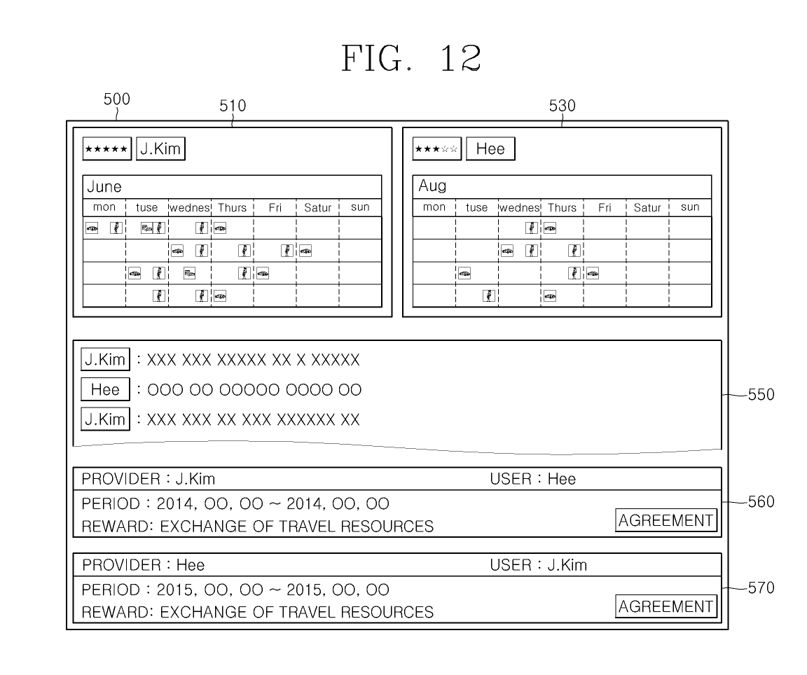

FIG. 12 illustrates another implementation example regarding the process of agreeing on sharing conditions with regard to the embodiment of FIG. 10.

In FIG. 12, as an implementation example in which agreement for exchanging surplus resources is reached between the provider of a resource for travel convenience and the user of a resource for travel convenience, a user becomes both the provider of a resource for travel convenience and the user of a resource for travel convenience.

As shown in FIG. 12, the surplus resource information 510 of a first user is presented, and at the same time, the surplus resource information 530 of a second user is also presented.

In order to reach a mutual agreement for sharing conditions regarding the two pieces of surplus resource information 510, 530, a chatting box 550 is formed as an agreement communication channel.

The first user and the second user proceed to reach an agreement for sharing conditions with the purpose of mutually exchanging surplus resources via the chatting box 550. When the agreement for sharing conditions is reached according to an agreement process, a sharing condition 560 for surplus resources, indicating that the first user is a provider of a resource for travel convenience and the second user is a user of a resource for travel convenience, is inputted, and a sharing condition 570 for surplus resources, indicating that the second user is a provider of a resource for travel convenience and the first user is a user of a resource for travel convenience, is inputted. When the first and second users mutually agree with the sharing conditions, an agreement is established based on the sharing conditions for mutually exchanging the surplus resources.

As such, in the present invention, since the service for sharing surplus resources between individuals as travel resources is provided, satisfactory sharing conditions for both the provider of a resource for travel convenience and the user of a resource for travel convenience can be reached through an agreement process therebetween.

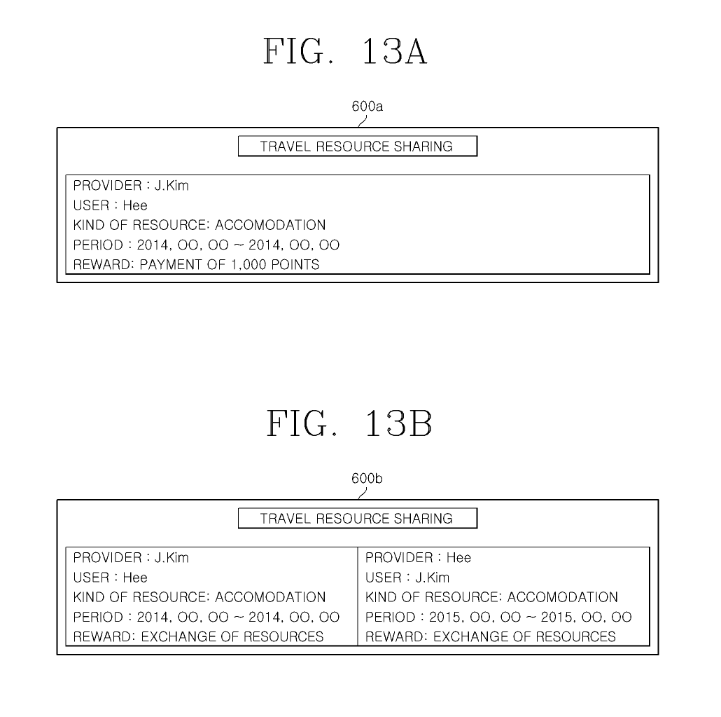

By connecting the provider of the resource for travel convenience and the user of the resource for travel convenience (S100), discussing the conditions for sharing the surplus resources as the travel resources (S200), as reviewed above, and when the provider of a resource for travel convenience and the user of the resource for travel convenience reach an agreement, the sharing agreement information generation unit 150 creates and provides sharing agreement information for surplus resources under the agreed-upon sharing conditions. In this regard, FIG. 13 illustrates an implementation example of sharing agreement information with regard to the method for sharing a surplus personal resource for travel convenience according to the present invention.

FIG. 13A shows an implementation example in which a point reward is provided in consideration of having shared the surplus resources as travel resources, and FIG. 13B shows an implementation example in which surplus resources owned by both the provider of the resource for travel convenience and the user of the resource for travel convenience are reciprocally exchanged and shared with each other. The sharing agreement information generation unit 150 creates and provides sharing agreement information as shown in FIGS. 13A and 13B. The sharing agreement information provided by the sharing agreement information generation unit 150 may serve as a kind of voucher between the provider of a resource for travel convenience and the user of a resource for travel convenience. A voucher may be in a form of a certificate describing the sharing agreement between the provider and the user.

As such, according to the present invention, an individual having a surplus resource, such as available personal time to act a guide, living space, a transportation means, or the like, may be connected with a traveler who needs the surplus resources so that the surplus resources can be shared.

In particular, since the surplus resources can be shared between individuals as travel resources, the surplus resources owned by the provider of a resource for travel convenience can be more efficiently utilized from the point of view of the provider of the resource for travel convenience, and the user of a resource for travel convenience can have a characterful trip and field experiences at a lower cost.

Although a preferred embodiment of the present invention has been described for illustrative purposes, those skilled in the art will appreciate that various modifications, additions and substitutions are possible, without departing from the scope and spirit of the invention as disclosed in the accompanying claims. Accordingly, the embodiments described in the present invention are intended for explaining the technical ideas of the present invention, but should not be construed as limiting the technical ideas. The scope of protection of the present invention should be interpreted based on the accompanying claims, and all technical ideas within the equivalent scope of the claims should be interpreted as being included in the scope of rights of the present invention.

What is claimed is:

1. A method for sharing a personal resource for travel convenience, comprising:
connecting, by a processor, a provider of a resource for travel convenience, who provides the personal resource as a travel resource, with a user of a resource for travel convenience who needs the travel resource;
enabling, by the processor, discussion on conditions for sharing the travel resource between the provider of the resource for travel convenience and the user of the resource for travel convenience to reach an agreement on the sharing conditions; and
creating, by the processor, sharing agreement information according to the sharing conditions and establishing sharing of the personal resource for travel convenience between the provider of the resource for travel convenience and the user of the resource for travel convenience.

2. The method of claim 1, wherein the connecting of the provider of the resource for travel convenience and the user of the resource for travel convenience comprises:
storing resource information about at least one of an unreserved time schedule for a guide, a living space for accommodation, and a mode of transportation possessed by the provider of the resource for travel convenience;
receiving sharing condition information about at least one travel resource of a time schedule for a guide, accommodations and a mode of transportation requested and inputted by the user of the resource for travel convenience, and searching the resource information corresponding to the sharing condition information;
providing the searched resource information to the user of the resource for travel convenience; and
confirming conditions for sharing a selected travel resource according to selection of the resource information by the user of the resource for travel convenience.

3. The method of claim 1, wherein the connecting of the provider of the resource for travel convenience with the user of the resource for travel convenience comprises:
storing travel resource request information about at least one travel resource of a time schedule for a guide, accommodations, and a mode of transportation requested by the user of the resource for travel convenience;
receiving sharing condition information for at least one travel resource of an unreserved time schedule for a guide, a living space for accommodations, and a form of transportation inputted by the provider of the resource for travel convenience and searching the travel resource request information corresponding to the sharing condition information;
providing searched travel resource request information to the provider of the resource for travel convenience; and
confirming sharing conditions regarding selected travel resource request information according to selection of the travel resource request information by the provider of the resource for travel convenience.

4. The method of claim 1, wherein the connecting of the provider of the resource for travel convenience with the user of the resource for travel convenience is performed by providing a credit rating or evaluation reviews regarding the provider of the resource for travel convenience or the user of the resource for travel convenience.

5. The method of claim 1, wherein the enabling of the discussion on the sharing conditions comprises:
holding a consultation about the conditions for sharing the travel resource between the provider of the resource for travel convenience and the user of the resource for travel convenience; and
reaching an agreement for sharing of the travel resource between the provider of the resource for travel convenience and the user of the resource for travel convenience according to the sharing conditions.

6. The method of claim 5, wherein the holding of the consultation about the conditions for sharing the travel resource is performed by providing at least one agreement mechanism of a chatting box, a message box between the provider of the resource for travel convenience and the user of the resource for travel convenience, and an edit box for inputting the sharing conditions, and by allowing the provider for the resource for travel convenience and the user of the resource for travel convenience to discuss the sharing conditions via the agreement mechanism.

7. The method of claim 1, wherein the establishing of the sharing of the personal resource comprises:
storing the sharing agreement information according to the conditions for sharing the travel resource agreed between the provider of the resource for travel convenience and the user of the resource for travel convenience; and
providing a reward to the provider of the resource for travel convenience according to the sharing agreement information.

8. The method of claim 7, wherein the reward is cash or points provided to the provider of the resource for travel convenience, or surplus resources exchanged between the user of the resource for travel convenience and the provider of the resource for travel convenience.

9. A system for sharing a personal resource for travel convenience, comprising:
a travel resource information storage unit, configured and adapted to store resource information, inputted by a provider of a resource for travel convenience, or travel resource request information, inputted by a user of a resource for travel convenience;
a user connection unit, configured and adapted to connect the provider of the resource for travel convenience and the user of the resource for travel convenience, and to induce an agreement for conditions for sharing a travel resource between the provider of the resource for travel convenience and the user of the resource for travel convenience; and
a sharing agreement information generation unit, configured and adapted to establish sharing of the travel resource based on the conditions for sharing the travel resource agreed between the provider of the resource for travel convenience and the user of the resource for travel convenience and to create and store sharing agreement information resulting therefrom.

10. The system of claim 9, further comprising a user information storage unit configured and adapted to store user information about the provider of the resource for travel convenience and user information about the user of the resource for travel convenience.

11. The system of claim 9, wherein the user connection unit comprises: a travel resource matching part, configured and adapted to enable the travel resource information storage unit to search resource information or travel resource request information based on sharing condition information inputted by the user of the resource for travel convenience or the provider of the resource for travel convenience, and to provide the searched resource information or travel resource request information to the user of the resource for travel convenience or the provider of the resource for travel convenience; and
an agreement mechanism providing part adapted to provide an agreement mechanism for discussing sharing conditions regarding sharing the resource information selected by the user of the resource for travel convenience, or sharing conditions regarding travel resource request information selected by the provider of the resource for travel convenience.

12. The system of claim 11, wherein the agreement mechanism providing part provides, as an agreement mechanism, a chatting box, a message box between the user of the resource for travel convenience and the provider of the resource for travel convenience, or an edit box for inputting sharing conditions.

13. The system of claim 10, wherein the sharing agreement information generation unit creates sharing agreement information including information about any one reward of no charge, cash, points, and exchange resulting from sharing of the travel resources, and
the user information storage unit stores the sharing agreement information by matching it with the user.

14. The system of claim 10, wherein the user information storage unit stores a credit rating or an evaluation review for the provider of the resource for travel convenience or the user of the resource for travel convenience, and
the user connection unit provides the credit rating or the evaluation review for the provider of the resource for travel convenience or the user of the resource for travel convenience.
